(19) United States
(12) Patent Application Publication
(10) Pub. No.: US 2011/0178891 A1
(43) Pub. Date: Jul. 21, 2011

(54) IN-EVENT SEAT EXCHANGE

(76) Inventor: Brent L. Charriere, Hudson, OH (US)

(21) Appl. No.: 13/009,095

(22) Filed: Jan. 19, 2011

Related U.S. Application Data
(60) Provisional application No. 61/296,458, filed on Jan. 19, 2010.

(51) Int. Cl. G06Q 30/00

(52) U.S. Cl. 705/26.2; 705/26.3

(57) ABSTRACT

A method for an in-event ticket exchange that occurs inside the ticked event venue after the original ticket holders have gained entry to the venue is provided. The method comprises reselling or exchanging event tickets on a tertiary market within the event venue after the tickets are used to gain admission to the event but while the tickets still retain a valid right to a seating/viewing location where an electronically accessible database connects sellers to buyers at the event who wish to upgrade their seating/viewing location.

### REFERENCE TO RELATED APPLICATION

This application claims priority to and the benefit of U.S. Provisional Application Ser. No. 61/296,458 which was filed Jan. 19, 2010, entitled IN-EVENT SEAT EXCHANGE, the entirety of which is hereby incorporated by reference as if fully set forth herein.

### FIELD OF THE INVENTION

The present invention relates generally to an on-line method for reselling tickets to an event, and more specifically to a method for an in-event ticket exchange that occurs inside the ticketed event venue after the original ticket holders have gained entry to the event venue.

### BACKGROUND OF THE INVENTION

There are many ways to obtain tickets for reserved seats at events such as spectator sports games, theatre, opera, orchestra, and the like, all of which may be referred to herein as reserved seat events, or simply “events.” The common aspect of these events is that a person in attendance generally requires a ticket to gain admission to the event venue and, furthermore, the ticket designates a specific event-viewing location (typically a numbered seat) that is reserved for the person bearing the ticket. Generally, tickets that reserve better seats or viewing locations for observing the event are sold at a higher price than less desirable seats/locations within the venue. Examples comprise: orchestra fifth row vs. balcony, box seats vs. upper deck, and reserved seats vs. general admission or standing room only.

Since they confer the right of entry, event tickets must be obtained outside of the event venue so that the ticket bearer may use the ticket to gain admission to the event. Tickets are traditionally obtained by purchase from the event box office or by prepaid subscription which includes internet purchase from the event sponsor or designated ticketing agents such as Ticketmaster® and the like, in addition to informal (if not illegal) brokers or sellers such as scalpers. Sometimes a ticket holder will stand outside of a venue in an attempt to resell an unwanted ticket, but this is an informal and uncomfortable process that can be illegal in many areas of the country. Alternatively, ticket scalpers/brokers will facilitate the process by both buying and reselling tickets outside of a venue. Sometimes a ticket holder may wish to “upgrade” their ticket by selling it to the scalper and then purchasing a different ticket for a more desirable reserved seating location. The scalper takes ownership of the ticket between buying it and selling it, and makes up for the inherent risk of owning unsold tickets by bargaining for the most advantageous price spread by buying as low as possible and then selling as high as possible. Therefore, the scalper is thus incentivized to provide the worst possible service to his clients.

More recently, ticket exchange services such as StubHub® and Flashseats® offer a legal option for the owner of an event ticket to resell the ticket to someone else. These services are typically used by a season ticket holder or any ticket holder who is unable to attend a particular event and would like to recoup at least a portion of the ticket face value. These exchange services act only as an intermediary in a no-risk transaction between a seller and a buyer, enabling a secure, simultaneous transfer of payment and ticket ownership. The service subtracts a fee from the payment transfer in an agreed upon manner, but, unlike a broker, the purchaser never takes physical possession of the ticket itself. If done over the internet, the purchaser must have a means for printing or otherwise obtaining the physical ticket, as an actual ticket is generally necessary to show as proof that the holder is entitled to gain entry to the event and to sit in the seat that is reserved by the ticket.

Prior art U.S. Pat. No. 6,496,809 to Nakfoor discloses a system and method for exchanging event tickets electronically in a secondary market where sellers place ask prices and buyers place bid prices. The database is used to receive and compare an asking price for the resale of a ticket from a potential seller and then compare that information to a bid price proposed by a potential buyer. However, this invention limits itself to problems associated only with the exchange of paperless tickets prior to the start of an event and focuses on reselling the right of entry to the venue. There is no provision or teaching designated toward the problem of reselling a partial ticket right, namely only the right to occupy a certain seating location after entry was gained through other means. Also, the invention is geared to paperless ticket resale and does not address how to exchange a physical ticket or ticket stub.

In another prior art ticket resale method, U.S. Pat. No. 6,107,932 to Walker et al. discloses a system and method for controlling access to an event requiring a ticket where a ticket holder may upgrade the seating location conveyed by accessing a computer database. However, this invention does not provide for a means for exchanging tickets between ticket holders. The focus of the system is a means for physically altering the ticket itself with additional revenue going to the event holder. Another problem that remains unsolved is the method will not work without a ticket including a means to be physically altered to show a new seating location. Therefore, the system will not work with most tickets sold today.

An example of a prior art method of using a central database for reselling tickets from a seller to a buyer on a secondary market is taught by U.S. Pat. No. 6,067,532 to Gebb. An original ticket may be redistributed from a seller who posts ticket information on the automated central database to a buyer. However, the disclosed invention requires distribution of the ticket by the host computer database. This limits the time and the rights conveyed for ticket redistribution to a time before the buyer gains admission to the venue since the ticket necessarily still conveys the right of entry in addition to the seating location. Therefore, a seller and buyer who have already been admitted to the event would have no means of transferring a physical original paper ticket.

All of these prior art systems and methods for buying, selling, and exchanging tickets are used outside of the physical confines of the event venue itself, and typically occur prior to the start of the event, because the person obtaining the ticket must use it to gain admission to the event. Therefore, a need remains for a system and method of exchanging tickets for an event within the venue after the ticket has been used to gain admittance while the tickets still convey valid rights to seating locations within the venue. More specifically, a need remains for a means and method of transferring an event ticket where the right of admission is expired but where the ticket still includes the right to occupy a specific location within the ticked venue through a tertiary market that allows a seller to convey a ticket with a partial right to a buyer who has gained admission to the event through other means.

### SUMMARY OF THE INVENTION

Accordingly, the present invention overcomes the limitations of the prior art by providing a system and method for using an on-line system for reselling tickets to an event. More particularly, the system and method is for an in-event ticket exchange between a seller and a buyer that may occur any time after the seller and the buyer have been admitted to the event venue so that the seller may obtain some value for the remaining ticket rights and the buyer may change or improve his event viewing location.

Consequently, the following presents a simplified summary of the invention in order to provide a basic understanding of some aspects of the invention. This summary is not an extensive overview of the invention. It is intended to neither identify key or critical elements of the invention nor delineate the scope of the invention. Its purpose is to present some concepts of the invention in a simplified form as a prelude to the more detailed description that is presented later.

It is an object of the invention to provide a system and/or a method for exchanging or upgrading a ticket for an event after the event has started and after an original ticket holder used the ticket to gain admission to the event.

It is a further object of the invention to present a system and/or a method for an event attendee ticket holder to recoup part of or possibly more than an original ticket cost while still being able to attend the event from a less desirable location after the event has started and after the ticket holder was admitted to the event venue.

It is an object of the invention to provide a system and/or a method for recovering part of or possibly more than an event ticket price for an admitted ticket holder who needs or desires to leave the event after the ticket holder was admitted or after the event has started.

It is yet a further object of the invention to present a system and/or a method of exchanging tickets after admission to the ticked event while a seller and a buyer are inside the physical confines of a venue.

It is another object of the invention to provide a system and/or a method of upgrading an event attendee's seat location after an event has started or after the attendee has been admitted to the event venue.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1 illustrates a top view of an event inside an event venue wherein ticket sellers and ticket buyers can exchange various tickets through utilizing an electronic system and a computer database.

FIG. 2 is a functional block diagram illustrating at least one aspect of the in-event seat exchange invention.

FIG. 3 is yet another functional block diagram illustrating yet another at least another aspect of the in-event seat exchange invention.

FIG. 4 illustrates a functional block diagram of yet another aspect or aspects of the in-event seat exchange invention.

### DETAILED DESCRIPTION OF THE INVENTION

The present invention is directed generally towards a system and a method of reselling event tickets through an on-line intermediary after the ticket has been used to gain admission to an event. More particularly, the system and/or method provide for the resale or exchange of tickets within the ticketed venue after the ticket has been used to gain admission to the event while the tickets still confer a right to occupy a specific seat or viewing location within the venue. Accordingly, the present invention will now be described with reference to the drawings, wherein like reference numerals are used to refer to like elements throughout. It should be understood that the description of these various aspects are merely illustrative and that they should not be taken in a limiting sense. In the following description, for purposes of explanation, numerous specific details are set forth in order to provide a thorough understanding of the present invention. It will be evident to one skilled in the art, however, that the present invention may be practiced without these specific details.

Many events limit access to the venue or physical location where the event is held by requiring a ticket for entry to the venue. Professional sporting events typically sell tickets to the event in advance on a primary market to earn revenue for the team. However, a ticket holder may come to receive the ticket by other means as well, such as winning a promotional contest, a gift, public relations give-always, complimentary tickets, and the like. In any event, the ticket traditionally retains a face value even if not sold to the original ticket holder. While the preferred invention focuses on the exchange of tickets to professional and college sporting events, any event requiring a ticket for entry is considered to be within the scope of the invention such as a baseball game, a football game, a theater show, a musical, a music concert, a method of transportation, and the like.

While there are many systems and methods for exchanging or reselling event tickets prior to the ticket holder gaining admission to the event on a secondary market, there are no options for exchange or resale on a tertiary market once the ticket owner uses the ticket to gain admission to the event. A secondary market for ticket sales is a “second” sale of a ticket where the second sale is not necessarily from the event venue or owner, but where the ticket is sold prior to the start of the event. A web service and a scalper are examples how sales may occur on the secondary market. The tertiary market comprises the sale or exchange of a ticket, a ticket stub, and the like where the right of entry has been used and/or is expired, but where the ticket and/or ticket stub still confers at least an additional right. While the most common additional right is the right to occupy a specific seating location, for example a seat number, other additional rights may comprise a viewing location, a loge, a bleacher location, a standing room only area, a restricted seat or section within the venue, improved food service/options, merchandise, personal services, and concierge services, and the like.

The term ticket refers to a device for conferring a right of admission to an event and for conferring an additional right such as a seating location; for example, a paper ticket, a ticket stub, a bar code, a coded magnetic strip, a token, an electronic device, an RFID tag, and any other means known to those skilled in the art for conferring such rights. An example of the system comprises a first ticket owner using a first ticket for gaining admittance to an event venue, the first ticket owner accessing an electronically accessible database through a plurality of internet accessible networking devices, an offer from a buyer requesting to purchase the ticket from the first ticket owner on the electronically accessible server, displaying an available tickets listing, a first ticket price, connectivity of the first ticket owner and the buyer, a ticket exchange, and a payment through a credit authority.

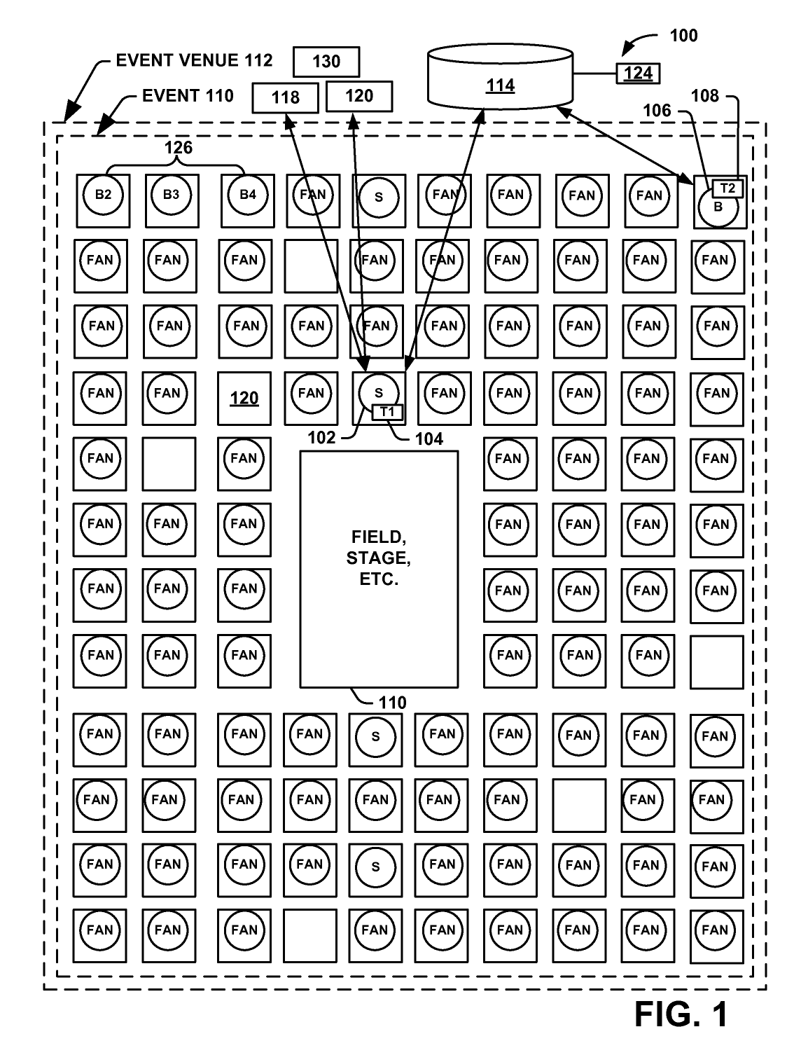

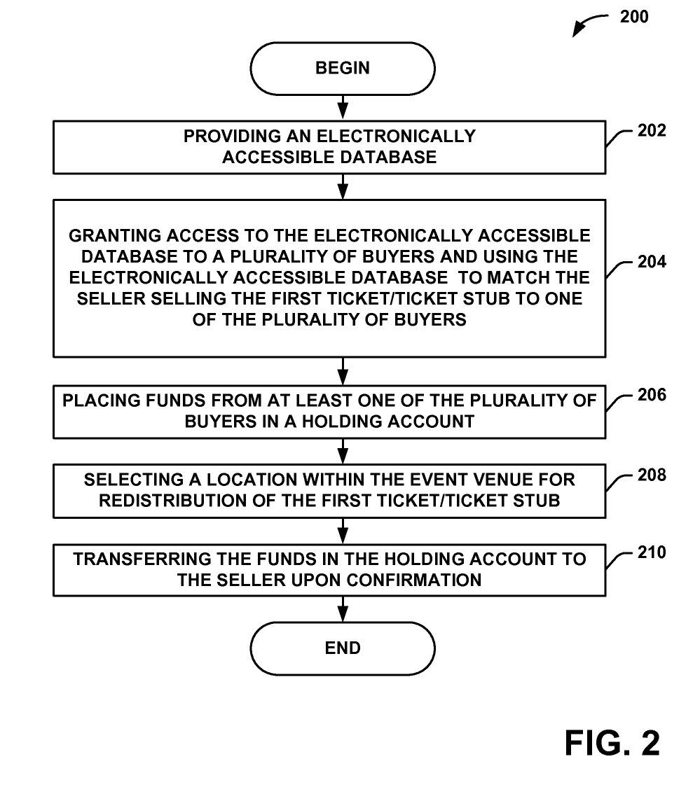

Referring now to the figures, FIGS. 1 and 2 are figures that help in understanding flow chart 200 for generally demonstrating a basic structure 100 and method 200 used for the redistribution/resale of event tickets/ticket stubs on a tertiary market within an event venue 112 after the tickets have been used to gain admission to the event venue 112 according to the present invention. In a preferred embodiment of the invention, a seller 102 possessing a first ticket 104 to an event 110 and a buyer 106 possessing a second ticket 108 to the event 110 use the first and second tickets 104, 108 respectively to gain admittance to the event venue 112 where the event 110 is being held. After gaining admission to the event venue 112, the first and second tickets 104, 108 often no longer confer a right of entry to the event venue 112. The seller 102 comprises anyone who owns or possesses an event ticket such as from an initial or secondary purchase, a season ticket holder, a prize winner, a complimentary ticket holder, a business or other organization that purchased the ticket, and the like. The buyer 106 comprises the same individuals or entities as the seller, but is further defined as one who requests a ticket conferring an unexpired right, such as a seating location upgrade for example.

While the seller 102 and the buyer 106 may receive permission to come and go from the event 110 as they choose, many events invalidate the conferred right of entry from a ticket once admission to the event venue 112 is gained. For example, the ticket may be torn in half leaving a ticket stub displaying a seating location, or a barcode scanner may electronically void the ticket for reentry once it is scanned at the event venue admission gate. However, most tickets confer additional property rights which still have considerable value such as the right to occupy a specific seating location within the event 110 after the ticket is used for admission to the event venue 112. For example, other ticket rights comprise a viewing location, a seat number, a reserved seat, a loge, a standing area, and a seat classification comprising preferred, general admission, business class, first class, and the like.

This invention recognizes that a ticket retains additional value after used for admission for the duration of the event 110. However, there is no current convenient method of regaining any value for a ticket once used for admission. Therefore, the method 200 provides a way of recouping some of or more than the face value from a used ticket. The method 200 provides an electronically accessible database 114 at 202. At 204, access to the electronically accessible database 114 is granted to a plurality of buyers 126 so that the electronically accessible database is used to match the seller 102 of the first ticket/ticket stub 104 to one of the plurality of buyers 126. For example, once the seller 102 establishes a desire to exchange or transfer the first ticket 104 the seller 102 makes contact with the electronically accessible database 114 through a database accessible device. Similarly, the buyer 106 may make contact with the electronically accessible database 114 to establish a desire to purchase a seating/viewing location upgrade.

The database accessible device is preferably an internet accessible device comprising a cell phone, a smart phone, a PDA, a wireless internet device, a laptop computer, a wireless notebook/notepad, an internet accessible tablet device, and the like. The database accessible device may be used to connect to the electronically accessible database 114 through systems comprising an email service, a web browser, a short message service application, and the like, or by any other devices of connection to an electronic or internet database. While the invention preferably works through the internet, the inventor recognizes that other systems of connecting to the electronically accessible database 114 may be employed by the seller 102 and the buyer 106 further comprising wired or cellular telephone service, a computer operator, a touchtone service, automated voice recognition, and other internet accessible devices known by those of skill in the art.

An internet service used to connect the seller 102 and the buyer 106 to the electronically accessible database 114 comprises any service deployable over the internet, Software as a Service (SaaS), software on demand, Platform as a Service (PaaS), cloud computing, computer network services/platforms, and the like, or by any service known to one skilled in the art. The electronically accessible database 114 further comprises a software database, a service internet database, a virtual internet database, and the like. Additionally, the electronically accessible database 114 may use a reliability rating service to ensure the integrity of transactions.

After the seller 102 accesses the electronically accessible database 114, the seller 102 may post or input a first ticket information 118 with a request to sell. The first ticket information 118 initially comprises at least an unexpired valid seating/viewing location 120 within the event venue 112 and an asking price. The preferred embodiment would allow the seller 102 and the buyer 106 to create a profile 124 on the electronically accessible database 114 comprising a username and a password before allowing a transaction to occur. The profile 124 may additionally comprise a PayPal® account, credit card information, billing information, personal information, addresses, contact information, an email address, and the like.

The electronically accessible database 114 may be accessed by the plurality of buyers 126 or potential buyers throughout the duration of the event 110 so that the plurality of buyers 126 may browse the available options for a potential upgrade. Once the buyer 106 locates the desired first ticket 104 and creates the profile 124, the electronically accessible database 114 matches the buyer 106 to the seller 102 and exchanges contact information from the profile 124 of the seller 102. Next, the buyer 106 contacts the seller 102 by email, phone, text, messaging service, or the like. If the seller 102 and the buyer 106 agree to the terms of the transaction, the buyer 106 allows the electronically accessible database 114 to place funds in a holding account sufficient to cover the price of the agreed upon exchange at 206.

If the seller 102 and the buyer 106 do not agree to the asking price, the electronically accessible database 114 may serve as a Bid/Ask platform with “Bid” responses comprising: “Accept”, “Reject”, and “Counteroffer” options. Then the buyer 106 may make a buyer counteroffer to the seller 102. The seller 102 may post a response to accept, reject, or make a seller counteroffer. The method 200 may end if an agreement between the seller 102 and the buyer 106 is not reached or may alternatively continue until the terms are acceptable to both the seller 102 and the buyer 106.

If an agreement is reached, at 208 the seller 102 and the buyer 106 select, with or without assistance from electronically accessible database 114, an exchange location 130 within the event venue 112 for redistribution of the first ticket 104 from the seller 102 to the buyer 106. The exchange location 130 may be anywhere within the event venue 112, for example, on the concourse next to the seller's section, at the seller's seat, at a gate, at an entrance, near a food vendor, and the like. Similarly, a time for exchange would be chosen, for example at the next time stoppage, intermission, a break, a timeout, and the like, or at any time convenient to the seller 102 and the buyer 106. Additionally, the event venue 112 could agree to reserve specific exchange locations such as a kiosk, ticket window, and the like.

After the seller 102 and the buyer 106, or their proxy meet at the exchange location 130, at 210 the buyer 106 may electronically approve the credit transfer from the funds withheld by the holding account after receiving the first ticket 104 from the seller 102. Simultaneously, the seller 102 would receive electronic confirmation of the transfer of funds by accessing the profile 124 on the electronically accessible database 114. Alternatively, the seller 102 may transfer the first ticket 104 to the buyer 106 for cash, merchandise, or other forms of consideration. Additionally, the seller 102 may exchange the first ticket 104 for the second ticket 108 from the buyer 106 in addition to other consideration.

No matter what the form of consideration, a service fee is collected by the electronically accessible database 114. The service fee may be withheld from the payment method selected by the seller 102 comprising a third party paying service, a credit authority, a credit card, a bank account, a deposit account, and the like. Alternatively, the service fee could be charged to the buyer 106 in full or in part, or the service fee could be a flat rate charged to a credit card, PayPal®, phone bill adder, and the like, charged to both the seller 102 and the buyer 106 when they post the first ticket 104 or create the profile 124. Additionally, separate charges for optional services comprising identifying or connecting the buyer 106 to the seller 102, negotiating a sale price, making a credit transaction between the seller 102 and the buyer 106, arranging the exchange location 130, and the like may be charged to the seller 102 or the buyer 106. Then the method 200 ends.

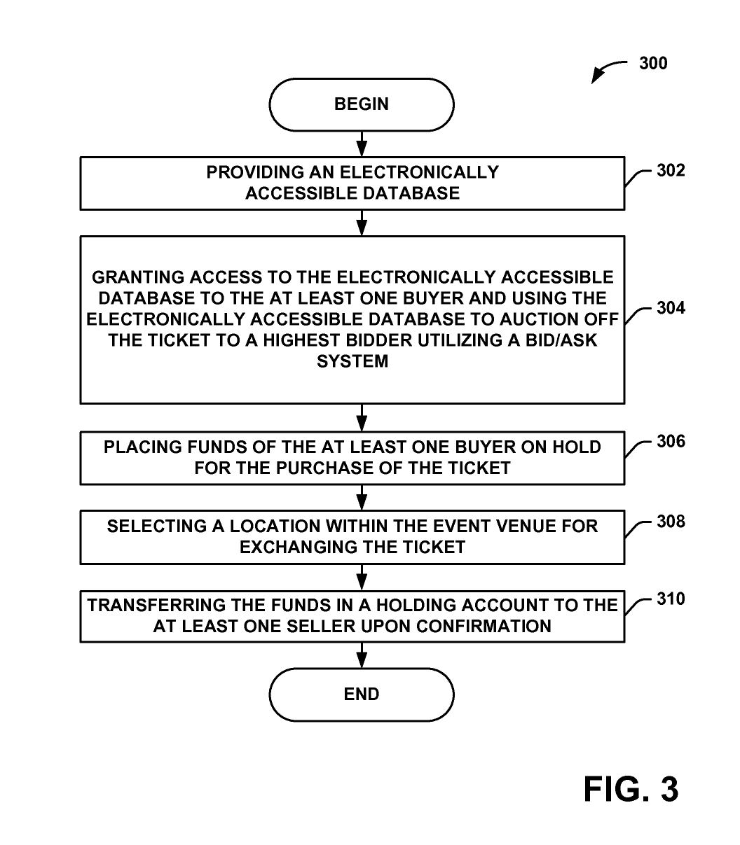

Referring now to FIG. 3, an additional embodiment is described for an in-event seat exchange method 300 between a plurality of sellers and a plurality of buyers 126 after the plurality of sellers and the plurality of buyers 126 have gained admission to an event venue 112. The method 300 provides an electronically accessible database at 302. The electronically accessible database 114 is then accessible to the plurality of sellers and the plurality of buyers 126 at 304. The electronically accessible database utilizes an auction format to auction a first ticket 104 to one of the plurality of buyers 126. The auction format comprises a Bid/Ask system further comprising: “Accept”, “Reject”, and “Counteroffer” options, a reverse auction-type format, and an exchange-type format. In addition, the at least one of the plurality of sellers may set a reserve price as a minimum sale price, and may request notification only when the reserve price is met. Also, the at least one of the plurality of sellers may set a reserve price that decreases in relation to the time left in an event 110 as the event 110 progresses. A first ticket information 118 may further comprise an expiration time for the sale of a first ticket 104 for any time period before the event 110 ends or while the first ticket 104 retains a right to confer, such as a post-event meeting or display, for example.

A “winning” buyer 106 may contact a seller 102 where the terms of the auction are acceptable. Alternatively, the electronically accessible database 114 may be used to contact both the seller 102 and the buyer 106 to inform them of the conclusion of the auction process.

As in the previous embodiment, the method 300 continues by placing funds from the plurality of buyers 126 in a holding account at 306, an exchange location 130 within the event venue 112 is selected at 308, and the transaction occurs in a similar manner as in the method 200 in FIG. 2 and then ends.

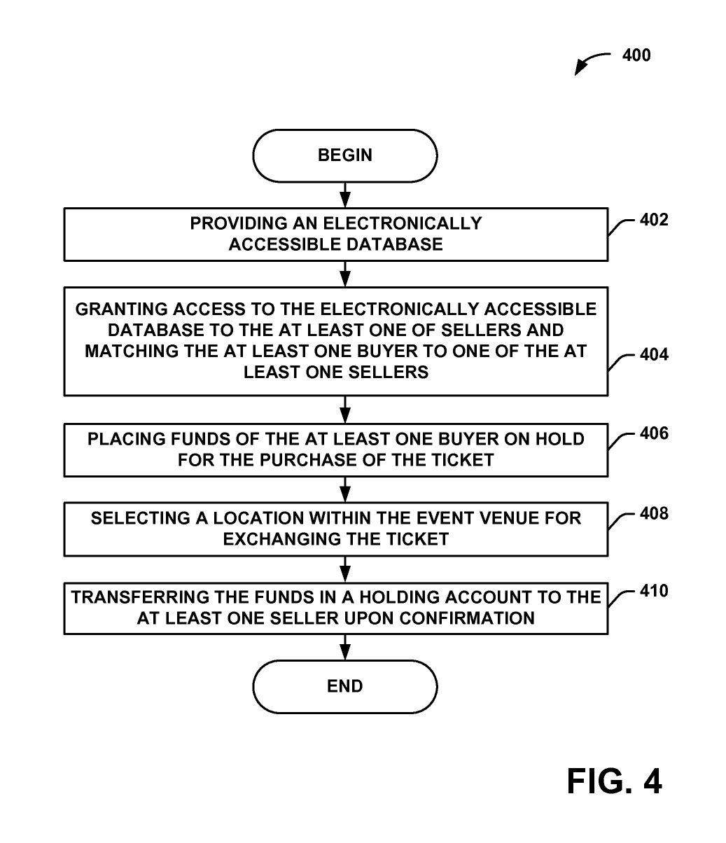

A further embodiment for an in-event seat exchange method 400 between a plurality of sellers and a plurality of buyers 126 after the plurality of sellers and the plurality of buyers 126 have used a ticket to an event 110 to obtain admission to an event venue 112 is described in FIG. 4. At 402, an electronically accessible database 114 is provided as in prior embodiments for at least one of the plurality of sellers to post a first ticket information 118 comprising at least a seating/viewing location 120 and an asking price at 404 Then the electronically accessible database 114 is accessible to the plurality of buyers 126 and matches at least one of the plurality of buyers 126 to the at least one of the sellers. In addition to the capability of the electronically accessible database 114 to receive a posting for a first ticket information 118 for a first ticket 104 from the plurality of sellers, at 404, the plurality of buyers 126 may post a buyer upgrade request on the electronically accessible database 114. The buyer upgrade request may comprise a request to obtain an upgraded seating/viewing location, a reserved seating location, a loge, and the like. Then the electronically accessible database 114 matches the plurality of sellers to the plurality of buyers 126 where the upgrade requests are similar to the first ticket information 118 offered by a seller 102.

The electronically accessible database 114 permits browsing of a plurality of available seller tickets and the buyer upgrade requests. Also, the plurality of sellers and the plurality of buyers 126 may sign up for a post from the electronically accessible database 114 of the available seller's tickets and the buyer upgrade requests respectively. The electronically accessible database 114 may then be used to either accept an offering or permit the plurality of sellers and the plurality of buyers 126 to negotiate acceptable terms for exchange.

As in prior embodiments, the method 400 allows the plurality of sellers and the plurality of buyers 126 to create a profile 124 on the electronically accessible database 114, the profile further comprising: a user name, a password, credit card and/or billing information, and a credit reliability and the plurality of buyers 126 to contact anyone on the electronically accessible database 114 to negotiate a price. Next, the method 400 continues by placing funds from the plurality of buyers 126 in a holding account 406, an exchange location 130 is selected at 408, and the transaction occurs if acceptable to all parties involved at 410. The method 400 optionally comprises an application wherein a bar scanning tool (not shown) is used to confirm the validity of the first ticket 104 and a second ticket 108 if necessary. The bar scanning tool may also be used to limit the number of times a ticket may be resold or exchanged as desired. In any event, the method 400 then ends.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described components (assemblies, devices, systems, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more other features of the other embodiments as may be desired and advantageous for any given or particular application. Furthermore, to the extent that the terms “including”, “includes”, “having”, “has”, “with”, or variants thereof are used in either the detailed description and the claims, such terms are intended to be inclusive in a similar manner to the term “comprising”.

What is claimed is:

1. A method for transferring a first ticket/ticket stub for an event from a seller to a buyer after both the seller having the first ticket/ticket stub and the buyer having a second ticket/ticket stub have already been admitted to the event venue, the method comprising:
providing an electronically accessible database wherein the seller can post a first ticket/ticket stub information on the database, the first ticket/ticket stub information further comprising a seat location within the event venue of the first ticket/ticket stub and an asking price of the first ticket/ticket stub;
granting access to the electronically accessible database to a plurality of buyers and using the electronically accessible database to match the seller selling the first ticket/ticket stub to one of the plurality of buyers;
placing funds from at least one of the plurality of buyers into a holding account for a purchase of the first ticket/ticket stub;
selecting/going to a location within the event venue for redistribution of the first ticket/ticket stub; and,
transferring the funds in the holding account to the seller upon confirmation from the at least one of the plurality of buyers after the exchange of the first ticket/ticket stub from the seller to the at least one of the plurality of buyers.

2. The method of claim 1, wherein the electronically accessible database comprises a software database, a service internet database and a virtual internet database, and wherein the seller comprises a plurality of sellers.

3. The method of claim 1, wherein the event comprises a baseball game, a football game, a sporting event, a theater show, a musical, a music concert, and a transportation device.

4. The method of claim 1, wherein the first and/or second ticket/ticket stub confers an expired right of entry to the event and a valid viewing location within the event venue.

5. The method of claim 4, wherein the valid viewing location designated by the first ticket/ticket stub comprises a seat number, a seat location, a loge, a reserved seat, a standing area, and a seat classification.

6. The method of claim 1, wherein the electronic database is accessible by devices comprising a telephone, a cellular telephone, a smart phone, a wireless internet device, an internet terminal, an electronic device, an email service, a web browser, and a short message service application.

7. The method of claim 1, wherein the electronically accessible database utilizes software comprising a bid/ask system to allow the at least one of the plurality of buyers to make a counteroffer(s) in response to the seller's posted asking price for the first ticket/ticket stub, and wherein the bid/ask system allows the seller to accept, reject, or respond to the at least one of the plurality of buyers with at least more than one counteroffer.

8. A method for transferring a ticket/ticket stub for an event from at least one seller to at least one buyer after both the at least one seller and the at least one buyer have already been admitted to the event, the method comprising:
providing an electronically accessible database wherein the at least one buyer can post a request to purchase a ticket with a different location within the event venue;
granting access to the electronically accessible database to the at least one of sellers and matching the at least one buyer to one of the at least one sellers;
placing funds of the at least one buyer on hold for the purchase of the ticket;
selecting/going to a location within the event venue for exchanging the ticket; and,
transferring the funds in a holding account to the at least one seller upon confirmation from the at least one buyer of the exchanging of the ticket from the at least one seller to the at least one buyer.

9. The method of claim 8, wherein of the at least one buyer and of the at least one seller negotiate the ticket price prior to the expiration of the event or no negotiation is completed.

10. The method of claim 8, wherein the at least one seller can post ticket information on the database and the at least one buyer can compare the available ticket information on the electronic database.

11. The method of claim 8, wherein the funds are conveyed from the at least one buyer to the at least one seller by a third party intermediary and a transaction fee is deducted from a negotiated ticket price.

12. The method of claim 8, wherein a right of entry to the event is expired, but wherein the ticket still confers a right to occupy a physical or virtual location within the event.

13. A method for transferring a ticket/ticket stub for an event from an at least one seller to an at least one buyer after both the at least one seller and the at least one buyer have already been admitted to the event, the method comprising:
providing an electronically accessible database wherein the at least one seller can post ticket information on the database, the ticket information further comprising a seat location within the event and an asking price;
granting access to the electronically accessible database to the at least one buyer and using the electronically accessible database to auction off the ticket to a highest bidder utilizing a bid/ask system;
placing the at least one buyer places funds on hold for the purchase of the ticket;
selecting/going to a location within the event venue for exchanging the ticket; and,
transferring the funds on hold to the at least one seller upon exchanging the ticket from the at least one seller to the at least one buyer.

14. The method of claim 13, wherein the at least one seller can set a reserve price for the ticket and is only notified when an offer at least one buyer meets or exceeds the reserve price.

15. The method of claim 13, wherein the at least one seller and the at least one buyer exchange a seller's physical ticket for a buyer's physical ticket and/or additional consideration.

16. The method of claim 13, wherein the at least one seller's ticket information further comprises an expiration time and the at least one seller and the at least one buyer create a profile on the database comprising a user name and a password prior to a transaction finalizing, credit card and billing information, and a credit reliability rating.

17. The method of claim 13, wherein the at least one seller provides contact information to the database and the at least one buyer contacts the at least one seller to negotiate a price.

18. The method of claim 13, wherein the ticket/ticket stub confers at least a right other than and in addition to the right of admission to the event.

19. The method of claim 18, wherein the right comprises a seating/viewing location within the event venue, improved food service, access to otherwise restricted event venue locations, merchandise, personal services, and concierge services.

20. The method of claim 16, wherein a bar scanner application confirms the validity of the at least one seller's ticket/ticket stub, and a ticket/ticket stub is prevented from more than one resale or exchange after the right of entry has expired.
